(19) United States
(12) Patent Application Publication
(10) Pub. No.: US 2025/0229992 A1
(43) Pub. Date: Jul. 17, 2025

(54) CONVEYOR DEVICE, TREATMENT SYSTEM, AND METHOD FOR CONVEYING WORKPIECES

(71) Applicant: DÜRR SYSTEMS AG, Stuttgart (DE)

(72) Inventor: Michael LAUER, Bietigheim-Bissingen (DE)

(21) Appl. No.: 18/698,984

(22) PCT Filed: Oct. 10, 2022
(86) PCT No.: PCT/DE2022/100748

§ 371 Date: Apr. 5, 2024

(30) Foreign Application Priority Data
Oct. 15, 2021 (DE) 10 2021 211 672.8

(51) Int. Cl. B65G 37/02; B60S 3/04; B62D 65/02; B62D 65/18; B65G 47/52

(52) U.S. Cl. CPC B65G 37/02; B62D 65/022; B62D 65/18; B65G 47/52; B60S 3/04; B65G 2201/0294

(57) ABSTRACT

The aim of the invention is to provide a device and a method for conveying workpieces, said device or method allowing a simple handling of workpieces. According to the invention, this is achieved in that a conveyor device comprises the following: one or more conveyor units, each of the one or more conveyor units comprising the following: a carriage, by means of which each conveyor unit can be moved along a main conveyor direction of the conveyor device; a receiving unit for receiving at least one workpiece; and a transfer unit, by means of which the at least one workpiece can be moved in a transverse direction oriented transversely to the main conveyor direction, in particular a workpiece can be transferred to another conveyor device and/or from another conveyor device.

### RELATED APPLICATION

This application is a national Phase of international application No. PCT/DE2022/100748 filed on Oct. 10, 2022, and claims the benefit of German application No. 10 2021 211 672.8 filed on Oct. 15, 2021, which are incorporated herein by reference in their entirety and for all purposes.

### FIELD OF DISCLOSURE

The present disclosure relates to the field of workpiece conveyance and workpiece treatment, in particular conveying, cleaning, and/or coating workpieces-for example, vehicle bodies or vehicle parts.

### SUMMARY

The object of examples disclosed herein is to provide a conveyor device and a method for conveying workpieces by means of which simple and reliable workpiece conveyance is possible.

This object is achieved by the conveyor device and by the method according to the independent claims.

The conveyor device serves to convey workpieces. Workpieces are in particular vehicle bodies or vehicle parts.

The conveyor device preferably comprises one or more conveyor units.

Each conveyor unit preferably serves to receive and convey one or more workpieces.

It can be advantageous if the one or more conveyor units each have the following:

a carriage by means of which each conveyor unit can be moved along a main conveyor direction of the conveyor device; and/or
a receiving unit for receiving at least one workpiece; and/or
a transfer unit by means of which the at least one workpiece can be moved in a transverse direction oriented transversely to the main conveyor direction.

By means of the transfer unit, the at least one workpiece can preferably be transferred to a further conveyor device and/or from a further conveyor device. The further conveyor device is in particular a station conveyor device.

The one or more conveyor units preferably each comprise a traction drive for driving the corresponding conveyor unit along the main conveyor direction.

The transverse direction is oriented transversely, in particular at least approximately perpendicular, to the main conveyor direction.

The main conveyor direction and/or the transverse direction preferably run at least approximately horizontally.

It can be provided that the receiving unit is movable by means of the transfer unit, in particular displaceable in the transverse direction relative to a chassis of the corresponding conveyor unit. In this case, the receiving unit is preferably moved, in particular displaced, together with the at least one workpiece arranged thereon.

It can be advantageous if the transfer unit comprises a transfer frame on which at least one conveyor element of the receiving unit is movably fastened.

The transfer frame is preferably movable relative to the chassis by means of an extension drive of the transfer unit, and in particular is displaceable in the transverse direction by a motor.

In one embodiment of examples disclosed herein, it can be provided that the receiving unit comprises at least one conveyor element, in particular at least one conveyor belt and/or at least one conveyor chain, onto which the at least one workpiece can be placed and which can be moved and/or driven by means of a transfer drive and/or an extension drive of the transfer unit.

For example, it can be provided that the at least one conveyor element can be driven by means of the transfer drive in order to move the at least one workpiece relative to the transfer frame, for example to transfer it to a further conveyor device.

Furthermore, it can be provided that the at least one conveyor element can be moved together with the transfer frame by means of the extension drive, in particular can be moved in the transverse direction, wherein the at least one workpiece then preferably remains stationary relative to the transfer frame.

It can be favorable if the transfer unit comprises an extension device by means of which the receiving unit is movable, in particular linearly displaceable, as a whole and/or relative to a chassis of the carriage.

The extension device comprises in particular an extension drive, by means of which the receiving unit as a whole can be moved, in particular can be displaced linearly.

It can be advantageous if the conveyor device comprises a housing which surrounds an interior. The interior preferably serves to convey the workpieces.

In particular, the interior forms a conveying space within which the workpieces can be conveyed along the main conveyor direction.

It can be provided that the conveyor units are each arranged completely within the interior and are thus completely surrounded by the housing.

However, it can preferably be provided that a transfer drive of the transfer unit, an extension drive of the extension device, and/or a traction drive of the carriage are arranged outside an interior surrounded by the housing.

The transfer drive of the transfer unit, the extension drive of the extension device and/or the traction drive of the carriage are preferably arranged and/or guided in an outer region and/or outside the housing, in particular on an outer side of a wall, for example side wall, of the housing.

It can be favorable if the housing comprises a feedthrough opening, in particular a feedthrough slot.

The one or more conveyor units preferably extend through the feedthrough opening, in particular through the feedthrough slot. As a result, a part arranged within the housing and a part arranged outside the housing is preferably formed for each conveyor unit.

The feedthrough opening, in particular the feedthrough slot, preferably extends at least approximately parallel to the main conveyor direction.

The one or more conveyor units can preferably be moved along the feedthrough opening, in particular along the feedthrough slot.

It can be provided that the receiving unit of each conveyor unit is arranged in the interior and can be moved completely within the housing by means of the transfer drive and/or the transfer unit, in particular an extension drive of the transfer unit.

One or more drives, for example the transfer drive, the extension drive and/or the traction drive, preferably act by means of one or more drive elements from outside the housing through the feedthrough opening on components of the corresponding conveyor unit arranged within the housing.

The conveyor device is particularly suitable for use as a component of a treatment system.

Examples disclosed herein therefore also relate to a treatment system for treating workpieces.

The treatment system serves in particular for cleaning and/or coating and/or heating/cooling vehicle bodies.

The treatment system preferably comprises a plurality of treatment stations and at least one conveyor device, for example a conveyor device according to examples disclosed herein. The conveyor device is in particular designed as a main conveyor device.

In one embodiment of the treatment system, it can be provided that one or more of the treatment stations each comprises one or more station conveyor devices.

The conveyor device designed as a main conveyor device serves in particular to convey the workpieces along the main conveyor direction. The one or more station conveyor devices are preferably arranged adjacent to the main conveyor device, in particular arranged distributed laterally along the main conveyor device and/or following one another.

It can be favorable if the workpieces can be transferred to the one or more station conveyor devices by means of the transfer unit of each conveyor unit of the main conveyor device and/or can be received from the one or more station conveyor devices.

A free space or gap can be arranged between the at least one conveyor device designed as a main conveyor device and the one or more station conveyor devices. Such a free space or gap results in particular if the one or more treatment stations can be closed off, for example by means of a gate.

By means of the transfer unit and/or the extension device and/or the receiving unit, the free space or gap can preferably be bridged.

For example, it can be provided that the transfer frame of the transfer unit is movable, in particular displaceable by a motor, in order to move the receiving unit, in particular the one or more conveyor elements of the receiving unit, in the direction and/or up to and/or overlapping with one or more conveyor elements of the station conveyor device. The respective workpieces can then easily be transferred from the main conveyor device to the station conveyor device.

By means of the at least one conveyor device designed as a main conveyor device, the workpieces can be conveyed, for example in a longitudinal orientation of the workpieces, along the main conveyor direction.

However, it is preferably provided that the workpieces can be conveyed along the main conveyor direction in a transverse orientation by means of the at least one conveyor device designed as a main conveyor device.

In this case, the workpieces can preferably be introduced into one or more treatment stations without an orientation change and/or can be transferred to one or more station conveyor devices without an orientation change. During conveying along the main conveyor direction, a transverse orientation is thus provided, while the workpieces are preferably oriented parallel to the transverse direction during conveying in the transverse direction, and thus can be conveyed in a longitudinal orientation of the workpieces, in particular can be transferred to one or more station conveyor devices.

Examples disclosed herein further relate to a method for treating workpieces, in particular for cleaning and/or coating and/or heating/cooling vehicle bodies or vehicle parts.

At least one conveyor device, for example a conveyor device according to examples disclosed herein, and/or at least one treatment system, for example a treatment system according to examples disclosed herein, are preferably used for carrying out the method.

It may be favorable if the method comprises the following:

conveying at least one workpiece by means of the conveyor device along the main conveyor direction;
introducing the at least one workpiece into a treatment chamber of one of the treatment stations, wherein the at least one workpiece is transferred to a station conveyor device of the treatment station by means of the transfer unit;
carrying out a treatment step in the treatment chamber;
discharging the at least one workpiece from the treatment chamber and/or transferring it to the receiving unit and/or transfer unit of the conveyor device.

The method according to examples disclosed herein preferably comprises one or more of the features and/or advantages described in connection with the conveyor device and/or the treatment system.

Furthermore, the conveyor device preferably comprises one or more of the features and/or advantages described in connection with the treatment system and/or the method.

Furthermore, the treatment system preferably comprises one or more of the features and/or advantages described in connection with the conveyor device and/or method.

Furthermore, according to examples disclosed herein, individual features, or a plurality of the following features and/or advantages, can be provided:

A treatment station preferably comprises a treatment container which surrounds a treatment chamber for receiving the workpieces.

Furthermore, it can be provided that a treatment station comprises a plurality of such treatment containers.

It is preferably provided that the treatment chamber can be flooded with a fluid.

The fluid is in particular a treatment fluid, for example a cleaning fluid, in particular for degreasing the workpieces. Furthermore, it can be provided that the fluid is a coating fluid, for example for phosphating or painting the workpieces.

It can be provided that the treatment container comprises at least one access opening for introducing the workpieces into the treatment chamber and/or for discharging the workpieces from the treatment chamber.

The treatment container preferably comprises a closure device for selectively closing and opening the at least one access opening.

It can be provided that the treatment container comprises a single access opening for introducing the workpieces into the treatment chamber and for discharging the workpieces from the treatment chamber.

Alternatively, it can be provided that the treatment container comprises an access opening for introducing the workpieces into the treatment chamber, and a further access opening for discharging the workpieces from the treatment chamber, wherein the access openings are then arranged in particular on opposite sides or ends or end walls of the treatment container.

It can be advantageous if at least one access opening is arranged and/or formed in one or more side walls of the treatment container, in particular in one or more end walls of the treatment container.

The treatment container is in particular substantially cuboid and preferably comprises a ceiling wall which is, for example, closed, a bottom wall, two or three closed side walls, and two further and/or one further side wall, which is provided with at least one access opening, wherein the at least one access opening is preferably completely closable by means of the closure device.

It can be favorable if the closure device serves to close off the at least one access opening in a fluid-tight manner.

For this purpose, the closure device comprises in particular a closure element which, for example, is self-locking and/or is provided with a self-locking mechanism and/or with a self-locking seal.

It can be advantageous if the closure device comprises a lifting device for raising and lowering a closure element of the closure device, in particular for lifting the closure element in order to bring it into an open position, and/or to lower the closure element in order to bring it into a closed position.

Furthermore, it can be provided that the closure element can be lowered by means of the lifting device in order to bring it into an open position, and/or can be lifted in order to bring it into a closed position.

Such a closure element can, for example, be a gate, in particular an airlock gate.

It can be favorable if the treatment station comprises a fluid tank for receiving a fluid, in particular a treatment fluid.

For flooding the treatment chamber, the fluid can preferably be introduced from the fluid tank into the treatment chamber by means of a fluid guide.

For emptying the treatment chamber, the fluid can preferably be guided from the treatment chamber back into the fluid tank by means of the fluid guide.

A direct connection between the treatment chamber and the fluid tank may be provided both for flooding and for emptying. Alternatively, one or more intermediate stations or other devices permitting flow may be provided.

It can be favorable if the conveyor device comprises one or more roller conveyors, lifting conveyors, sliding conveyors and/or rack picking devices for conveying and/or moving the workpieces, in particular for introducing the workpieces into the treatment chamber and/or for discharging the workpieces from the treatment chamber and/or for conveying the workpieces from one treatment station to the next, in particular along the main conveyor direction.

It may be favorable if one or more workpieces are arranged on a workpiece carrier. A workpiece carrier is in particular a skid, preferably for receiving a workpiece taking the form of a vehicle body.

The conveying and/or movement of the workpieces then preferably takes place together with the workpiece carrier. As such, the wording “conveying the workpieces” or “moving the workpieces” also means conveying or moving at least one workpiece carrier together with at least one workpiece arranged thereon.

In one embodiment of examples disclosed herein, it can be provided that the workpieces are arranged, in particular fastened, on the workpiece carrier through an entire treatment unit of the treatment system.

Alternatively, it can be provided that the workpieces are conveyed through an entire treatment unit of the treatment system without a workpiece carrier. The workpieces can then be transferred, in particular in the treatment chambers, to stationary workpiece receptacles provided for this purpose, or can be deposited thereon and/or can be fastened thereto.

The workpieces can preferably be moved, in particular introduced into the treatment chamber and/or discharged from the treatment chamber, along a horizontal plane by means of the conveyor device.

In particular, it can be provided that the workpieces can be moved, in particular introduced into the treatment chamber and/or can be discharged from the treatment chamber, by means of the conveyor device on the same plane and/or level.

It can be favorable if all bearing points coming into contact with fluid, in particular treatment fluid, during operation of the conveyor device are designed as lubricant-free and/or graphite-free components, or exclusively comprise lubricant-free and/or graphite-free components. In particular, all plain bearings and/or rolling bearings are preferably designed to be lubrication-free and/or graphite-free.

In one embodiment of examples disclosed herein, it can be provided that all bearing points coming into contact during operation of the conveyor device with fluid, in particular treatment fluid, are designed as bronze-sintered bushings and/or as plastics elements, or comprise bronze-sintered bushings and/or plastics elements.

Preferably, all components coming into contact during operation of the conveyor device with fluid, in particular treatment fluid, are designed to permanently touch and/or contact the fluid, for example because the material is stainless steel, in particular V4A.

Further preferred features and/or advantages of examples disclosed herein form the subject-matter of the following description and the drawings illustrating embodiments.

### BRIEF DESCRIPTION OF THE DRAWINGS

FIG. 1 is a schematic perspective representation of an embodiment of a treatment system in which two treatment units arranged one above the other are each provided with a plurality of treatment stations, wherein the workpieces can be conveyed in a transverse orientation along a main conveyor direction by means of a conveyor device;

FIG. 2 is a schematic plan view from above of the treatment system of FIG. 1;

FIG. 3 is a schematic perspective representation of an optimized embodiment of a conveyor device for the treatment system of FIG. 1;

FIG. 4 is an enlarged representation of region IV in FIG. 3;

FIG. 5 is a further schematic perspective view of the conveyor device of FIG. 3;

FIG. 6 is a further schematic perspective view of the conveyor device of FIG. 3;

FIG. 7 is a schematic side view of the conveyor device of FIG. 3—with a viewing direction along the main conveyor direction; and

FIG. 8 is a schematic plan view of an upper side of the conveyor device of FIG. 3.

The same or functionally equivalent elements are provided with the same reference signs in all figures.

### DETAILED DESCRIPTION

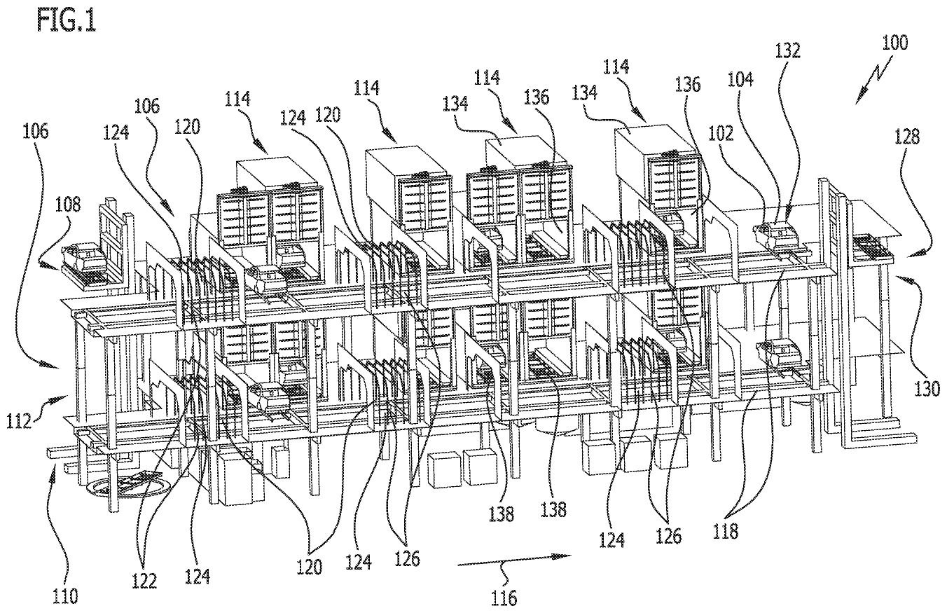

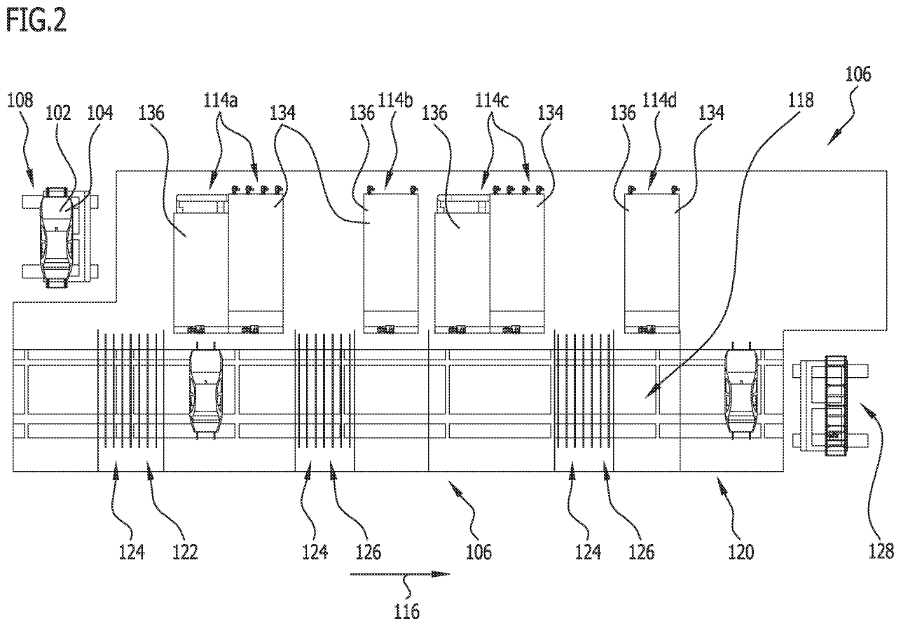

A treatment system shown in FIGS. 1 and 2 and denoted as a whole by 100 serves to treat workpieces 102, for example vehicle bodies 104.

The treatment system 100 comprises one or more treatment units 106, for example two treatment units 106, through which the workpieces 102 optionally run in order to carry out a plurality of treatment steps.

In the embodiment of the treatment system 100 shown in FIGS. 1 and 2, a feed station 108 ensures the supply to the treatment units 106.

The feed station 108 is preferably a component of a conveyor device 110 of the treatment system 100.

Preferably, the feed station 108 forms a distributor device 112 for distributing the workpieces 102 to the treatment units 106.

The feed station 108 is designed, for example, as an elevator, and serves to supply the workpieces 102 to treatment units 106 arranged on different levels of the treatment system 100.

The treatment system 100, in particular each treatment unit 106, comprises one or more treatment stations 114 for treating the workpieces 102, in particular for carrying out flooding processes, which will be described in more detail.

The treatment stations 114 are arranged in succession along a main conveying direction 116 of the conveying device 110.

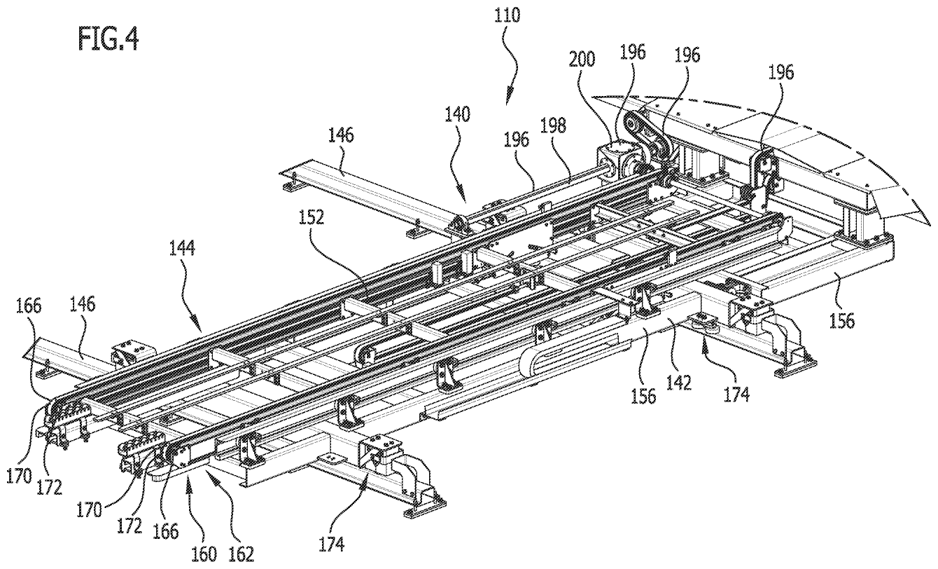

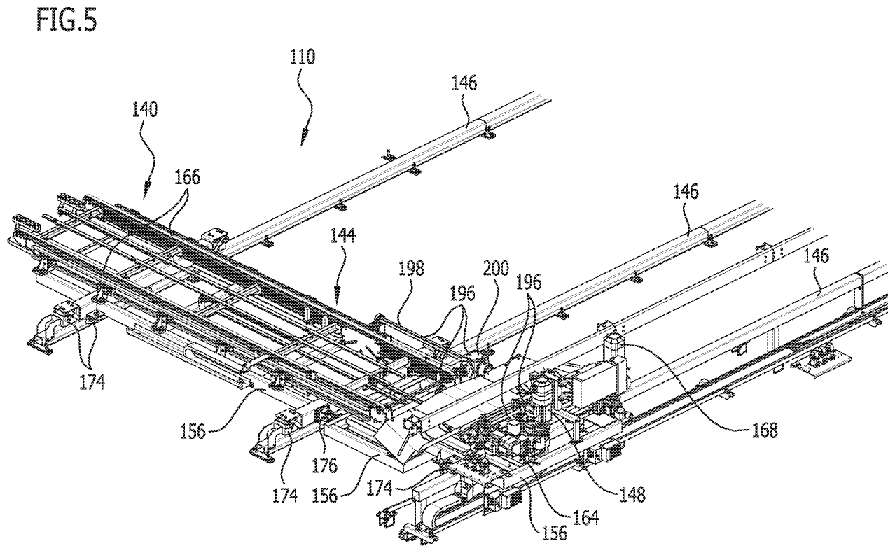

In the first embodiment of the treatment system 100 shown in FIGS. 1 to 6, a main conveying path 118 of the conveyor device 110 is provided which extends along all treatment stations 114 and from which the workpieces 102 can be supplied to the individual treatment stations 114.

The main conveying path 118 comprises in particular one or more tunnel sections 120 for housing at least individual sections of the main conveying path 118.

Furthermore, the main conveying path 118 preferably comprises one or more cleaning stations 122 and/or spraying stations 124 and/or rinsing stations 126.

The cleaning station 122, the spraying station 124 and/or the rinsing station 126 are arranged and/or formed in particular with respect to the main conveyor direction 116 before one or more treatment stations 114, between a plurality of treatment stations 114 and/or after one or more treatment stations 114.

After the treatment of the workpieces 102, the same can be conveyed further by means of a removal station 128.

The removal station 128 in particular forms a combining device 130 for combining the workpieces 102 handled at the different treatment units 106, and for further conveying them together.

In the first embodiment of the treatment system 100 shown in FIGS. 1 and 2, the workpieces 102 can in particular be conveyed in a transverse orientation 132, in particular can be conveyed along the main conveyor direction 116 in a transverse orientation 132.

The vehicle bodies 104 are preferably introduced into the treatment stations 114, which in particular laterally adjoin the main conveying path 118, along a longitudinal axis of the same.

As can be seen in particular in FIG. 2, a first treatment station 114a, a second treatment station 114b, a third treatment station 114c, and a fourth treatment station 114d are provided in each treatment unit 106, for example.

A fluid tank 134 is preferably assigned to each treatment station 114a, 114b, 114c, 114d.

Moreover, each treatment station 114a, 114b, 114c, 114d comprises one or more treatment containers 136 for carrying out a workpiece treatment.

The workpieces 102 can be treated in particular with one or more fluids taking the form of a liquid.

As can be seen in particular from FIGS. 1 and 2, the possibility of closing off the treatment stations 114 results in a free space or a gap between a station conveyor device 138 arranged within the corresponding treatment station 114 and the conveyor device 110 used outside for conveying along the main conveyor direction 116. This free space or gap is preferably bridged by a suitable design of the conveyor device 110.

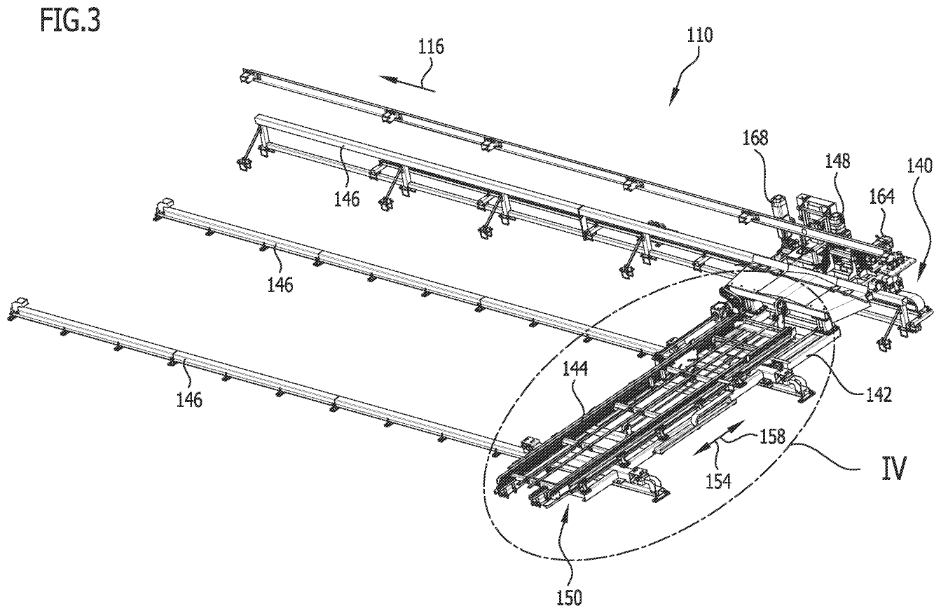

For example, such a conveyor device 110 is shown in FIGS. 3 to 8.

The conveyor unit 110 comprises a plurality of conveyor units 140, which each comprise a carriage 142 and a receiving unit 144.

The receiving unit 144 serves to receive a workpiece 102. By means of the carriage 142, the corresponding conveyor unit 140 is movable along the main conveyor direction 116 in order ultimately to convey the workpieces 102 along the main conveyor direction 116.

The conveyor unit 140 is thereby mounted so as to be movable on a plurality of running rails 146.

The carriage 142 preferably comprises a traction drive 148 which, for example, comprises an electric motor and a friction wheel in order to move the carriage 142 along the main conveyor direction 116.

The conveyor unit 140 preferably further comprises a transfer unit 150.

The transfer unit 150 comprises in particular a transfer frame 152 on which the receiving unit 144 is arranged.

The transfer frame 152 is arranged in particular so as to be displaceable on the carriage 142 in a transfer direction 154, in particular on a chassis 156 of the carriage 142.

The transfer direction 154 is in particular a transverse direction 158 which, for example, is oriented transversely, in particular at least approximately perpendicular, to the main conveyor direction 116-and/or at least approximately horizontally.

The conveyor unit 140 preferably comprises an extension device 160, by means of which the transfer frame 152 can preferably be displaced relative to the chassis 156 of the carriage 142.

The extension device 160 is in particular a telescopic device 162 by means of which the receiving unit 144 can be extended and/or pulled out in the transverse direction 158.

The extension device 160 preferably comprises an extension drive 164, by means of which the displacement of the transfer frame 152 can be effected by motor.

The receiving unit 144 preferably comprises one or more conveyor elements 166, onto which the at least one workpiece 102 can be placed.

For example, two conveyor elements 166 are provided, which are in particular movable.

A transfer drive 168 of the transfer unit 150 is preferably provided for moving the conveyor elements 166.

One or more conveyor elements 166 is in particular designed as a conveyor belt 170 or a conveyor chain 172.

The one or more conveyor elements 166 are preferably mounted so as to be displaceable or rotatable on the transfer frame 152.

The chassis 156 of the carriage 142 of the conveyor unit 140 preferably comprises a plurality of, for example six, guide units 174, by means of which the carriage 142 is mounted on the running rails 146. For this purpose, the guide units 174 in particular comprise a plurality of bearing rollers.

Furthermore, the chassis 156 preferably comprises one or more articulation elements 176. In this way, in particular if more than two running rails 146 are used, a reliable and/or uniform support and/or guidance on the running rails 146 can be ensured.

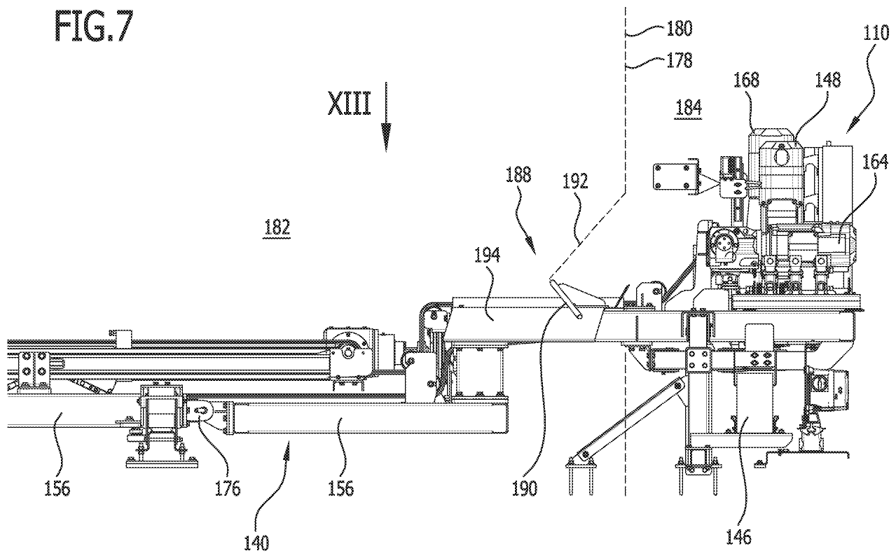

As indicated in particular in FIG. 7, the conveyor device 110 and/or the treatment system 100 preferably comprise a housing 178.

A wall 180 of the housing 178 is in particular a side wall of the housing 178 and delimits an interior 182 of the conveyor device 110 and/or the treatment system 100.

The interior 182 is in particular the space in which the workpieces 102 are arranged when they are conveyed by means of the conveyor device 110, in particular during conveying along the main conveyor direction 116.

In particular if workpieces are treated in the interior 182, it may be advantageous to protect electrical and electronic components of the conveyor units 140.

In the embodiment of the conveyor device 110 shown in FIGS. 3 to 8, it is therefore provided that the conveyor units 140 are arranged partially within the interior 182 and partially outside the housing 178, i.e. in an outer region 184.

Each conveyor unit 140 preferably extends through a feedthrough opening 186, which is not shown in detail, in the wall 180 of the housing 178.

The feedthrough opening 186 is designed in particular as a feedthrough slot and extends along the main conveyor direction 116, so that the conveyor units 140 can be moved along the feedthrough opening 186, while in particular electrical and/or electronic components of the conveyor unit 140 are arranged in the protected outer region 184 and remain there.

Each conveyor unit 140 preferably comprises a feedthrough unit 188 which forms the part of the conveyor unit 140 which extends through the feedthrough opening 186.

The feedthrough unit 188 comprises in particular an actuating element 190 for actuating one or more closure elements 192. Furthermore, the feedthrough unit 188 preferably comprises a cover element 194.

By means of the actuating element 190, closure elements 192 that close the feedthrough opening 186 are in particular operatable, for example can be opened. The closure elements 192 are preferably only open when a conveyor unit 140 effects the opening thereof. As soon as the conveyor unit 140 has been moved past the corresponding closure element 192, it preferably automatically moves into a closed position, in particular due to gravity.

The feedthrough opening 186 is thus preferably designed always to be as far as possible closed in order to separate the interior 182 from the outer region 184 as reliably as possible.

As can be seen in particular in FIG. 7, the traction drive 148, the extension drive 164 and the transfer drive 168 are arranged in the outer region 184.

While the other components for driving the conveyor unit 140 along the main conveyor direction 116 are also arranged in the outer region 184, for example a friction wheel and/or a transmission, etc., the components of the conveyor unit 140 to be driven by means of the extension drive 164 and/or the transfer drive 168 are preferably arranged in the interior 182.

The conveyor unit 140 preferably comprises a plurality of drive elements 196, by means of which movement transmission and/or force transmission from the outer region 184 into the interior 182 takes place.

For this purpose, the drive elements 196 are designed in particular as drive rods, drive shafts, drive chains, etc.

One or more drive elements 196 extend in particular through the feedthrough opening 186 and/or form a component of the feedthrough unit 188.

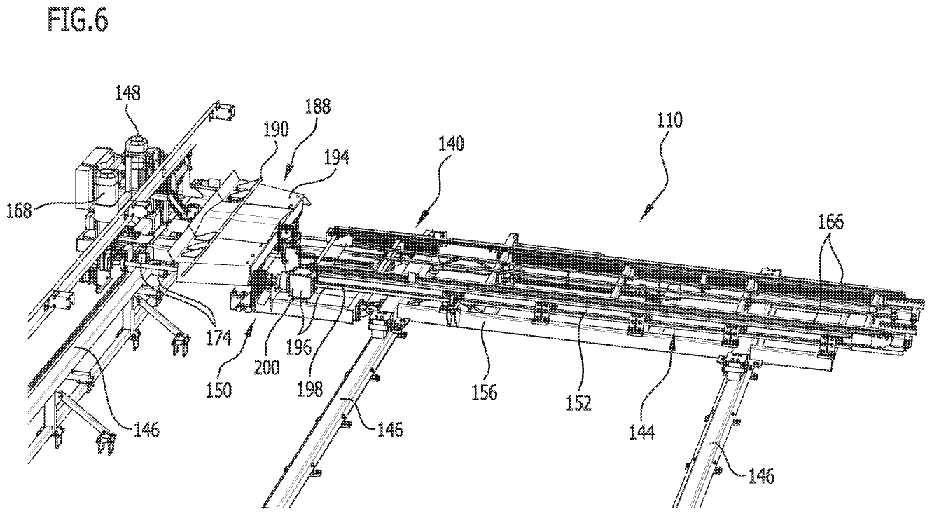

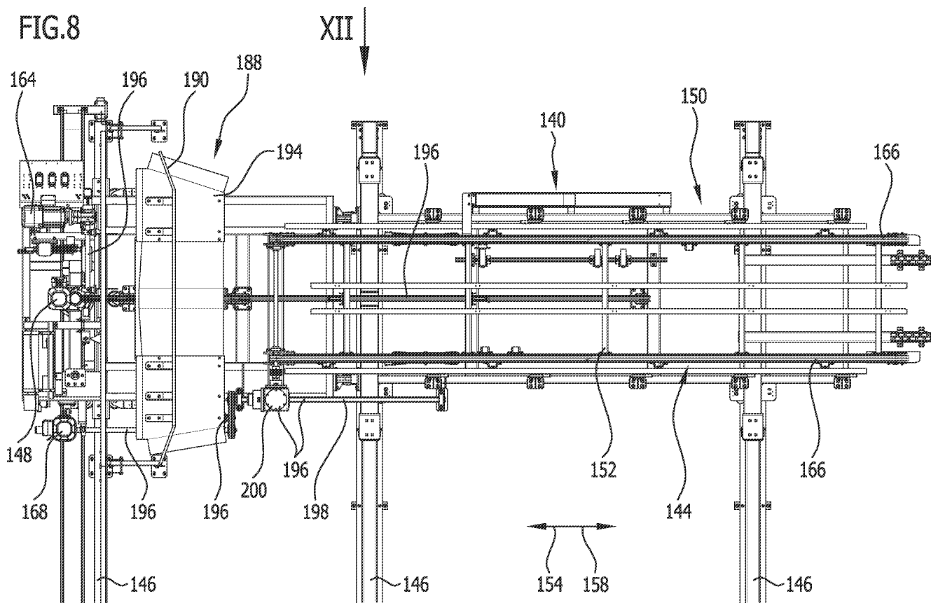

As can be seen in particular in FIG. 6 and FIG. 8, the transfer unit 150 can comprise a drive element 196 designed as a transmission shaft 198, which can be driven by means of the transfer drive 168.

The transmission shaft 198 is in particular oriented parallel to the transverse direction 158.

A transmission drive 200 of the transfer unit 150 preferably forms a further drive element 196 and is arranged so as to be displaceable along the transverse direction 158 on the transmission shaft 198.

The transmission drive 200 serves in particular to transmit a movement and/or force to the conveyor elements 166 in order ultimately to be able to move the workpiece along the transverse direction 158.

Since the conveyor elements 166 are arranged on the transfer frame 152 and this transfer frame 152 is displaceable along the transverse direction 158, the force transmission by means of the transmission drive 200 also has to be ensured independently of its position along the transverse direction 158. This is achieved by the displaceability of the transmission drive 200 along the transmission shaft 198.

The extension drive 164 also comprises a drive element 196, for example a drive chain or a drive belt, which extends from the outer region 184 into the interior 182, and in particular engages the transfer frame 152 in order to move it in the transverse direction 158 relative to the chassis 156 of the conveyor unit 140, by driving by means of the extension drive 164.

The embodiment of the conveyor device 110 shown in FIGS. 3 to 8 makes it possible in particular to convey the workpieces 102 along the main conveyor direction 116.

For transferring the workpieces 102 to the treatment stations 114, in particular to one or more station conveyor devices 138, a gap or free space arranged in between must be traversed. For this purpose, the receiving unit 144 is preferably displaceable as a whole in the transverse direction 158. For this purpose, the transfer frame 152 is moved in the transverse direction 158, in particular moved toward the station conveyor device 138, by means of the extension drive 164. As soon as a desired end position has been reached, for example as soon as an overlap has been established between the conveyor elements 166 of the conveyor device 110 and conveyor elements of the station conveyor device 138, the receiving unit 144 is actuated by means of the transfer drive 168. In particular, the conveyor elements 166 are set in motion in order to move the workpiece received at the receiving unit 144 in the direction of the station conveyor device 138 and to transfer it to the latter.

As soon as the workpiece 102 has been transferred, the receiving unit 144 is preferably removed from the treatment station 114, in particular in order to enable a gate of the treatment station 114 to close.

As soon as a treatment process in the corresponding treatment station 114 is complete, the door can then, for example, be opened and the receiving unit 144 can be moved to the station conveyor device 138 to once again pick up the workpiece 102.

Ultimately, the selected features of the conveyor device 110 result in reliable conveying and treatment of the workpieces 102.

### List of Reference Signs

100 Treatment installation
102 Workpiece
104 Vehicle body
106 Treatment unit
108 Feed station
110 Conveyor device
112 Distributor device
114 Treatment station
116 Main conveyor direction
118 Main conveying path
120 Tunnel section
122 Cleaning station
124 Spraying station
126 Rinsing station
128 Removal station
130 Combining device
132 Transverse orientation
134 Fluid tank
136 Treatment container
138 Station conveyor device
140 Conveyor unit
142 Carriage
144 Receiving unit
146 Running rail
148 Traction drive
150 Transfer unit
152 Transfer frame
154 Transfer direction
156 Chassis
158 Transverse direction
160 Extension device
162 Telescopic device
164 Extension drive
166 Conveyor element
168 Transfer drive
170 Conveyor belt
172 Conveyor chain
174 Guide unit
176 Articulation element
178 Housing
180 Wall
182 Interior
184 Outer region
186 Feedthrough opening
188 Feedthrough unit
190 Actuating element
192 Closing element
194 Cover element
196 Drive element
198 Transmission shaft
200 Transmission drive

1. Conveyor device for conveying workpieces, optionally vehicle bodies, wherein the conveyor device comprises the following:
one or more conveyor units, wherein the one or more conveyor units each include:
a carriage by which each of the conveyor units can be moved along a main conveyor direction of the conveyor device;
a receiving unit for receiving at least one workpiece;
a transfer unit by which the at least one workpiece can be moved in a transverse direction oriented transverse to the main conveyor direction, optionally to a further conveyor device and/or from a further conveyor device.

2. Conveyor device according to claim 1, wherein the receiving unit is movable relative to a chassis of the corresponding conveyor unit by the transfer unit, wherein the receiving unit optionally is movable by motor in the transverse direction.

3. Conveyor device according to claim 2, wherein the transfer unit includes a transfer frame on which at least one conveyor element of the receiving unit is movably fastened, and wherein the transfer frame is movable relative to the chassis by an extension drive of the transfer unit, optionally can be displaced in the transverse direction by a motor.

4. Conveyor device according to claim 1, wherein the receiving unit includes at least one conveyor element, optionally at least one conveyor belt and/or at least one conveyor chain, onto which the at least one workpiece can be placed and which can be moved and/or driven by a transfer drive and/or an extension drive of the transfer unit.

5. Conveyor device according to claim 1, wherein the transfer unit includes an extension device by which the receiving unit is movable, optionally linearly displaceable, as a whole and/or relative to a chassis of the carriage.

6. Conveyor device according to claim 1, wherein the conveyor device includes a housing which surrounds an interior which conveys the workpieces.

7. Conveyor device according to claim 6, wherein a transfer drive of the transfer unit, an extension drive of the extension device, and/or a traction drive of the carriage are arranged outside an interior surrounded by the housing.

8. Conveyor device according to claim 6, wherein the housing includes a feedthrough opening, optionally a feedthrough slot, through which the one or more conveyor units extend, wherein the feedthrough opening, optionally the feedthrough slot, extends at least approximately parallel to the main conveyor direction, and wherein the one or more conveyor units can be moved along the feedthrough opening, optionally along the feedthrough slot.

9. Conveyor device according to claim 6, wherein the receiving unit of each conveyor unit is arranged in the interior and is movable completely within the housing by the transfer drive and/or the transfer unit, optionally an extension drive of the transfer unit.

10. Treatment system for treating workpieces, optionally for cleaning and/or coating and/or heating/cooling vehicle bodies, wherein the treatment system includes a plurality of treatment stations and at least one conveyor device designed as a main conveyor device according to claim 1.

11. Treatment system according to claim 10, wherein one or more of the treatment stations each includes one or more station conveyor devices, wherein the at least one conveyor device is a main conveyor device by which the workpieces can be conveyed along the main conveyor direction, and wherein the workpieces can be transferred by means of the transfer units of the conveyor units to the one or more station conveyor devices, and/or can be taken from the one or more station conveyor devices.

12. Treatment system according to claim 11, wherein a free space or gap is arranged between the at least one conveyor device designed as a main conveyor device and the one or more station conveyor devices, which free space or gap can be bridged by moving, optionally displacement by motor, of the receiving unit, optionally the transfer frame of the transfer unit.

13. Treatment system according to claim 10, wherein the workpieces can be conveyed along the main conveyor direction in a transverse orientation by the at least one conveyor device designed as a main conveyor device, and can be introduced into one or more treatment stations without change in orientation, and/or can be transferred to one or more station conveyor devices without change in orientation.

14. Method for treating workpieces, optionally for cleaning and/or coating and/or heating/cooling vehicle bodies, wherein at least one conveyor device according to claim 1 is used.

15. Method according to claim 14, further including the following:
conveying at least one workpiece by the conveyor device along the main conveyor direction;
introducing the at least one workpiece into a treatment chamber of one of the treatment stations, wherein the at least one workpiece is transferred by means of the transfer unit to a station conveyor device of the treatment station;
carrying out a treatment step in the treatment chamber;
discharging the at least one workpiece from the treatment chamber and transferring the at least one workpiece to the receiving unit and/or transfer unit of the conveyor device.

16. Method for treating workpieces, optionally for cleaning and/or coating and/or heating/cooling vehicle bodies, wherein at least one treatment system according to claim 10 is used.

17. Method according to claim 16, further including the following:
conveying at least one workpiece by the conveyor device along the main conveyor direction;
introducing the at least one workpiece into a treatment chamber of one of the treatment stations, wherein the at least one workpiece is transferred by means of the transfer unit to a station conveyor device of the treatment station;
carrying out a treatment step in the treatment chamber;
discharging the at least one workpiece from the treatment chamber and transferring the at least one workpiece to the receiving unit and/or transfer unit of the conveyor device.
